(19) United States
(12) Patent Application Publication
(10) Pub. No.: US 2013/0234999 A1
(43) Pub. Date: Sep. 12, 2013

(54) INPUT PEN

(71) Applicant: CASIO COMPUTER CO., LTD., Tokyo (JP)

(72) Inventor: Toshiya KUNO, Tokyo (JP)

(73) Assignee: CASIO COMPUTER CO., LTD., Tokyo (JP)

(21) Appl. No.: 13/789,597

(22) Filed: Mar. 7, 2013

(30) Foreign Application Priority Data
Mar. 9, 2012 (JP) 2012-053114

(51) Int. Cl. G06F 3/0354

(52) U.S. Cl. CPC G06F 3/03545
USPC 345/179

(57) ABSTRACT

An input pen is provided which enables a soft writing feeling and sliding of the pen tip that realizes favorable handwritten input of fine letters, fine line drawings, and the like during an input operation on a touch panel. This input pen has a structure in which the tip end portion of a pen tip member is formed by a resin material having the properties of rubber being impregnated into a base member composed of a porous rigid body, and is partially exposed on the surface of the tip end portion. As a result, a writing feeling (sensations such as flexibility and sense of friction) which is the same as or similar to that when writing letters, line drawings, and the like on paper using a pen is actualized when an input operation is performed on a touch panel using the input pen.

### CROSS-REFERENCE TO RELATED APPLICATION

This application is based upon and claims the benefit of priority from the prior Japanese Patent Application No. 2012-053114, filed Mar. 9, 2012, the entire contents of which is incorporated herein by reference.

### BACKGROUND OF THE INVENTION

1. Field of the Invention

The present invention relates to an input pen. Specifically, the present invention relates to an input pen that is used to perform an input operation on an electronic device including a touch panel.

2. Description of the Related Art

Electronic devices including a so-called touch panel, such as smartphones (highly functional mobile phones) and tablet type information terminals, have been rapidly spreading in recent years. The touch panel is an input device including a display device such as a liquid crystal or organic Electroluminescent (EL) display device, and a touch sensor arranged on the front surface (the side to be viewed) of the display device or formed integrally with the display device. By viewing text information or an image displayed on the display device, and touching an arbitrary area on the display with a stylus pen or a finger, the user can perform a desired input operation.

This type of input device (including the touch panel type and the pen input type), on which an input operation is performed by the user touching it with a stylus pen or a finger (human body), has been used in various products for years. For example, it is used in pen tablets that are used as peripheral devices for desktop and laptop personal computers, portable gaming devices, car navigation systems, mobile information terminals (Personal Digital Assistants [PDAs]), cash machines (Automated Teller Machines [ATMs]) for banking institutions, and ticket vending machines. That is, this type of input device is used in a wide range of product areas.

Regarding touch panels, there are various types of known touch panels (touch sensors). For example, in smartphones and tablet type information terminals which have been rapidly spreading in recent years, the capacitance type touch panel is mainly used. In the capacitance type touch panel, a change in electrostatic capacitance is detected that occurs between a fingertip (or a conductive material equivalent to a finger) and a conductive film on the touch-panel side by the touch panel being touched by the fingertip (or a conductive material equivalent to a finger), whereby positional information is detected.

In the resistive film type touch panel which has most commonly been used in some smartphones and tablet type information terminals, car navigation systems, mobile information terminals, etc., conduction between two opposing resistive films occurs by the touch panel being touched by a fingertip or a stylus pen, and positional information is detected by the partial pressure ratio of the resistance of the resistive films at the time being measured.

Also, in pen tablets that are used as peripheral devices for personal computers, and monitors having a touch-panel feature, the electromagnetic induction type touch panel is used. In the electromagnetic induction type touch panel, electromagnetic energy is detected on the touch-panel side by the touch panel (input pad or monitor) being touched by an electronic pen that generates a magnetic field, and positional information is detected thereby.

As just described, touch panels have a structure where a touch sensor is arranged on the front surface of a display device or a structure where a touch sensor is formed integrally with a display device. Therefore, a plate made of a transparent rigid material, such as glass or transparent acrylic, is generally used for the surface layer of a touch panel to improve the display quality of the display device and to protect the touch panel from physical pressure and scratches caused by contact with a stylus pen, a finger, etc.

On the other hand, the pen tips of stylus pens and electronic pens (hereinafter collectively referred to as “input pen”) for performing input operations on a touch panel are generally composed of a resin material. That is, they are composed of a rigid material similar to that of the surface layers of touch panels. Note that the pen tips of some input pens have a rubber tip (cap) attached thereto, or are made of a soft material such as compressed felt. Input pens such as these are described in detail in, for example, Japanese Patent Application Laid-open (Kokai) Publication No. 11-232022.

In the above-described case where the front surface of a touch panel and the pen tip of an input pen are composed of rigid materials, the user feels extreme firmness when performing an input operation using the input pen. In addition, the pen tip slips very easily. Therefore, there is a problem in that desirable handwritten input of fine letters, fine line drawings, etc. is difficult.

As the above-mentioned method of solving this problem, a rubber tip (cap) is attached to a pen tip. However, rubber material has high elasticity, which causes deformation and buckling to occur through repeated input operations. Accordingly, the product has a short life span and is not particularly user-friendly. In addition, in the other method compressed felt is used in a pen tip. However, because compressed felt has high abrasiveness, this product also has a short life span and is not particularly user-friendly.

### SUMMARY OF THE INVENTION

In accordance with one aspect of the present invention, there is provided an input pen comprising: a pen tip member including a porous base member and a rubber material, wherein the rubber material is united with the porous base member within the porous base member, and partially exposed at least on surface of the porous base member.

The above and further objects and novel features of the present invention will more fully appear from the following detailed description when the same is read in conjunction with the accompanying drawings. It is to be expressly understood, however, that the drawings are for the purpose of illustration only and are not intended as a definition of the limits of the invention.

### BRIEF DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1A and FIG. 1B are schematic diagrams showing an input pen according to a first embodiment of the present invention;

FIG. 2A and FIG. 2B are schematic diagrams showing the pen tip of the input pen according to the first embodiment;

FIG. 3A and FIG. 3B are schematic diagrams showing the pen tip of an input pen according to a second embodiment; and

FIG. 4A and FIG. 4B are schematic diagrams showing structural examples of electronic devices to which the input pen of the present invention has been applied.

### DETAILED DESCRIPTION OF THE PREFERRED EMBODIMENTS

An input pen according to the embodiments of the present invention will hereinafter be described in detail.

### First Embodiment

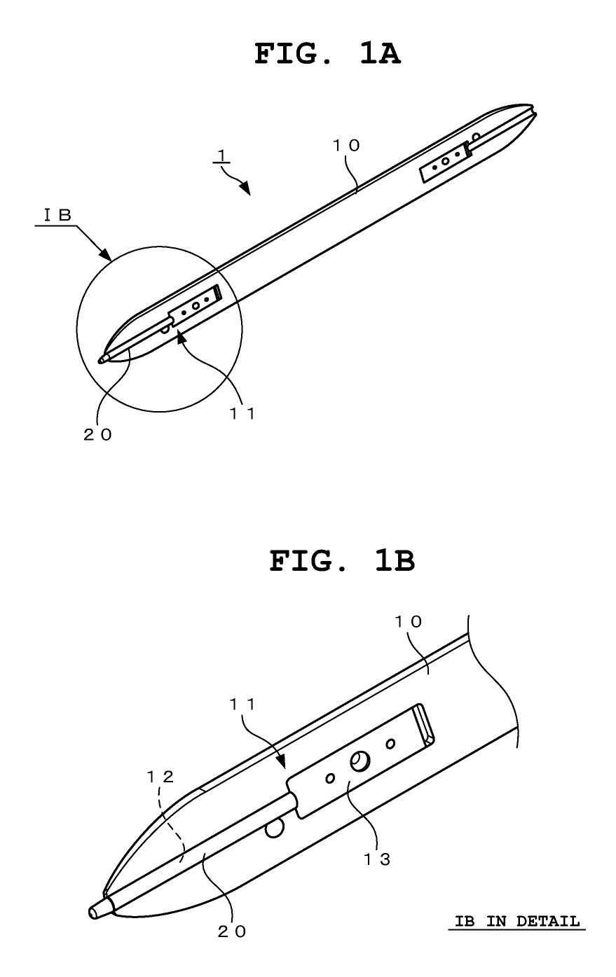

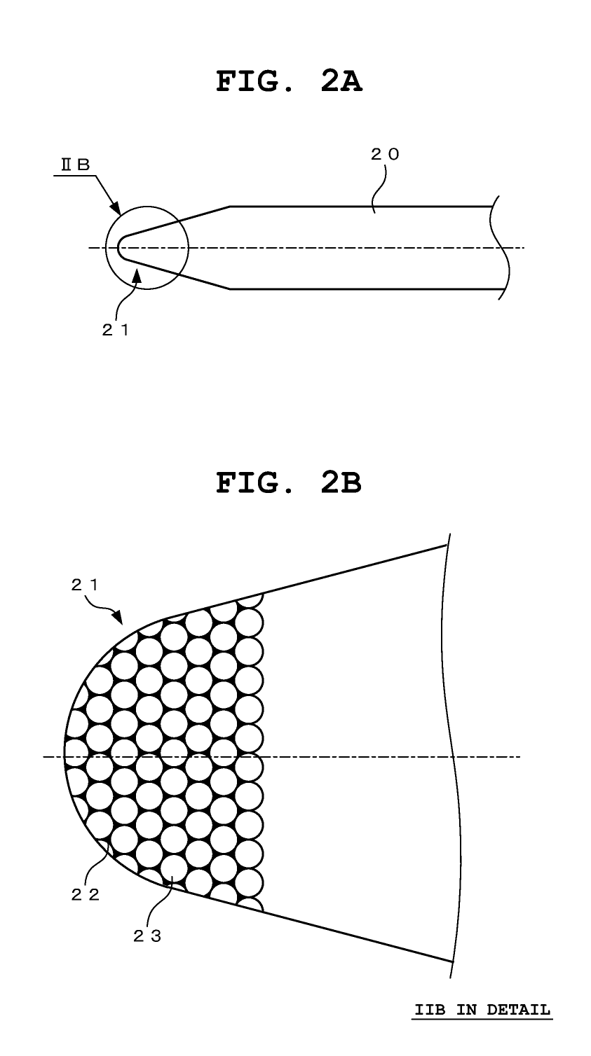

FIG. 1A and FIG. 1B are schematic diagrams of an input pen according to a first embodiment of the present invention, of which FIG. 1A is a perspective view showing the overall structure of the input pen according to the first embodiment, and FIG. 1B is a perspective view showing a detailed structure of section IB shown in FIG. 1A. FIG. 2A and FIG. 2B are schematic diagrams showing the pen tip of the input pen according to the first embodiment, of which FIG. 2A is a diagram of the pen tip of the input pen according to the first embodiment, and FIG. 2B is a cross-sectional view showing a detailed structure of section IIB shown in FIG. 2A.

This input pen 1 according to the first embodiment includes a pen body 10 and a pen tip member 20, as shown in FIG. 1A and FIG. 1B.

The pen body 10 includes a rod-shaped, rectangular column-shaped, or circular column-shaped member that extends linearly in a certain direction. In at least one end of the pen body 10 in the extending direction, an attaching and fixing section 11 for detachably fixing the pen tip member 20 is provided. The attaching and fixing section 11 basically includes a guide groove 12 provided in the end portion of the pen body 10 and a fixing member 13 for fixing the pen tip member 20 to the pen body 10.

The guide groove 12 is a linear groove section for attaching the pen tip member 20 to a predetermined area along the extending direction of the pen body 10. The inner surface of the guide groove 12 is curved so that the side surface of the pen tip member 20 having a substantially circular column shape engages with the guide groove 12. The fixing member 13 is a member for fixing the pen tip member 20 attached such that the side surface engages with the guide groove 12 to the pen body 10. This fixing member 13 is structured such that the pen tip member 20 is adjustably attached to the pen body 10. By the attaching and fixing section 11 being provided, the projection length of the tip end portion 21 (the portion that comes in contact with a touch panel) of the pen tip member 20 projecting from the pen body 10 is adjusted, and the pen tip member 20 is firmly fixed to the pen body 10.

The pen tip member 20 includes a base member 22 having a substantially circular column shape, and at least one tip end portion 21 of the base member 22 which comes in contact with a touch panel has a hemispherical shape or a convex shape having a predetermined roundness. The base member 22 constituting the pen tip member 20 is a porous rigid body, for which a member has been adopted that has sufficient flexural strength so that deformation and buckling does not occur at least during an input operation performed on a touch panel by the input pen 1. Specifically, the base member 22 is constituted by a member by which a resin material having the properties of rubber described later favorably impregnates the pore portion of the base member 22 when impregnation processing with the resin material is performed. For example, wood or foamed resin, or a member having equivalent or similar properties can be favorably adopted.

The resin material is formed such that a portion thereof is exposed on or adhesively covers at least the hemispherical surface of the tip end portion 21 of the pen tip member 20. Specifically, in the structure of the first embodiment, impregnation processing with a material 23 having the properties of rubber has been performed on at least the tip end portion 21 of the pen tip member 20, as shown in FIG. 2B. That is, the porous base member 22 constituting the tip end portion 21 of the pen tip member 20 has been impregnated and united with the material 23 which has the properties of rubber and is in liquid form having relatively low viscosity. As a result, in this structure, the material 23 having the properties of rubber has been united with the base member 22 of the tip end portion 21 such that it is partially exposed on the surface of the tip end portion 21. Here, when being united, the material (impregnation material) 23 impregnated into the porous base member 22 forms vesicles in the pore section of the base member 22, as shown in FIG. 2B. In addition, because the impregnation material 23 is being surrounded by the base member 22, the impregnation material 23 and the base member 22 are united with high bonding strength. Portions of the vesicles of the impregnation material 23 are exposed on the surface of the tip end portion 21 of the pen tip member 20.

In the first embodiment, common natural rubber, organic synthetic rubber (such as Nitrile Rubber [NBR] or Butadiene Rubber [BR]), non-organic synthetic rubber (such as silicone rubber or fluoro-rubber), or the like can be used as the above-described material (impregnation material) 23 having the properties of rubber. In addition, a resin material, such as an elastomer material, having the same or similar properties as the above-described rubber materials can also be used instead of the rubber materials. Note that the processing for impregnating a material having the properties of rubber into a porous base member can be easily actualized using, for example, a general-purpose vacuum impregnating device.

(Verification of Operational Effects)

Next, the operational effects of the above-described input pen according to the first embodiment will be verified in detail.

First, in an input operation that is performed on a touch panel using an input pen, a certain degree of a sense of friction (i.e., sliding of the pen tip) and a certain degree of flexibility (i.e., soft writing feeling) should preferably exist. That is, the sensation of the input operation should preferably be the same or similar to that when writing letters, line drawings, and the like on paper using a pen. The sense of friction and the flexibility that are felt when the user is writing letters, line drawings, and the like on paper using a pen are created as a result of “paper”, which has flexibility and in which fibers are complexly arranged, being used. That is, the sense of friction and the flexibility correspond to the writing feeling.

In a method for replicating this sensation (writing feeling) into an input operation that is performed on a touch panel using an input pen, for example, a special surface treatment is performed on the touch-panel surface so that the surface is roughen while having flexibility. However, in a case where this method is used to improve the sensation of an input operation, the transmittance of the touch panel is reduced due to the surface treatment. Accordingly, there is a problem in that the quality of display transmitted and viewed through the touch panel is reduced.

Also, in another method for replicating the sense of friction and the flexibility, which is felt when the user is writing letters and line drawings on paper using a pen, into an input operation that is performed on a touch panel using an input pen, a rubber material is used in the entire pen tip portion of the input pen, or a rubber cap is attached to the pen tip portion. However, there is a problem in this method in that, because the rubber material is an elastic body, deformation and buckling due to repeated stress occur by repeatedly performed input operations, which leads to cracks and eventually breakage. If the rigidity of the pen tip portion is increased to suppress the occurrence of buckling and cracks in the pen tip portion, another problem arises in that the sense of friction during an input operation is lessened.

Also, in another method for replicating the above-described sensation, for example, a material such as rigid compressed felt is used in the pen tip portion of an input pen. This rigid compressed felt can replicate some flexibility and some sense of friction when an input operation is performed on a touch panel despite having a rigid body. However, its durability and anti-worn property are inferior when touching and sliding back and forth the pen tip portion on a touch panel at a predetermined pressure. Accordingly, there is a problem in that the product life span becomes short, and therefore its practicality is poor.

In contrast, in the present embodiment, the state and the material of the surface of the touch panel are not changed. In the structure of the present embodiment, the tip end portion 21 of the pen tip member 20 of the input pen 1 is formed by a resin material having the properties of rubber being impregnated into the base member 22 having a porous rigid body such that the resin material is partially exposed on the surface of the tip end portion 21, as described above. As a result, the above-described problems are solved. In the present embodiment, the writing feeling is soft and the pen tip does not easily slip during an input operation on a touch panel, whereby a sensation that is the same as or similar to that when writing letters, line drawings, and the like on paper using a pen can be actualized. Therefore, handwritten input of fine letters, fine line drawings, and the like can be favorably realized on a touch panel using an input pen.

That is, even in cases where an electronic device including a touch panel has a structure in which a transparent rigid material such as glass or transparent acrylic is used for the surface layer of the touch panel, the present embodiment actualizes a favorable writing feeling (sensations such as flexibility and a sense of friction) in an input operation by an input pen, while ensuring the transmittance of the display screen and suppressing the deterioration of the display quality.

Also, in the present embodiment, the tip end portion 21 of the pen tip member 20 having a porous rigid body is impregnated with a resin material having the properties of rubber, and the resin material is partially exposed on the surface of the tip end portion 21. As a result, as compared to a structure where the entire pen tip portion is composed of a rubber material, the structure of the present embodiment can better ensure the rigidity (flexural strength) of the pen tip member 20 and the tip end portion 21 as well as ensuring the flexibility and the friction of rubber only by the interface where the input pen 1 and the touch panel come in contact with each other. Accordingly, in the present embodiment, the buckling, deformation, breakage, cracks, and the like of the pen tip of an input pen is prevented and a favorable writing feeling is actualized even when the pen tip is touched on a touch panel and slid back and forth at a predetermined pressure (writing pressure) during an input operation.

Moreover, in the present embodiment, a porous rigid body such as wood or foamed resin is used as the base member 22 constituting the pen tip member 20, and a resin material having the properties of rubber is impregnated into at least the tip end portion 21 of the pen tip member 20. Here, for comparison to the present embodiment, a structure will be verified in which a non-porous high-rigidity body, such as metal, is used for the base member of a pen tip member, and a material having the properties of rubber is adhered to or applied to the surface of the base member using a method such as insert molding or coating (referred to as a rubber film for convenience of explanation). In this comparative structure, bonding strength at the interface between the non-porous high rigidity body constituting the pen tip member and the rubber film is low, and the difference between their material properties is large. Therefore, there is a problem in that when touching and sliding back and forth the pen tip on a touch panel at a predetermined writing pressure, peeling easily occurs at the interface (bonded surface) between the rigid body and the rubber film.

In the present embodiment having the above-described structure, because of the impregnation material 23, the porous base member 22 constituting the pen tip member 20 has rigidity similar to that of a rubber material, as compared to the above-described metal. That is, the rigidity difference between the respective materials is relatively small. In addition, the impregnation material 23 having the properties of rubber has been impregnated into and united with the base member 22 with high bonding strength such that it is partially exposed on the surface of the base member 22. Therefore, in the present embodiment, peeling, etc. of the pen tip is prevented and a favorable writing feeling is actualized even when touching and sliding back and forth the pen tip on a touch panel at a predetermined writing pressure.

In the present embodiment, a method has been described in which a resin material (rubber material) is impregnated into at least the tip end portion 21 of the pen tip member 20 having a porous rigid body by a vacuum impregnating device. However, the present invention is not limited thereto. All that is required is that a resin material is strongly united with the pen tip member 20 having a porous rigid body, and partially exposed on or adhesively covers the surface of the tip end portion 21 of the pen tip member 20. Therefore, various manufacturing methods can be used. For example, a method (surface coat processing) can be used in which a resin material (rubber material) is melted by a solvent or the like and used to coat the porous base member 22 having the same or similar properties as those of wood. Alternatively, a method can be used in which a resin material (rubber material) in liquid form is inserted into and injection molded in the porous base member 22. By these methods as well, the operational effects of the above-described embodiment can be achieved.

### Second Embodiment

Next, an input pen according to a second embodiment of the present invention will be described.

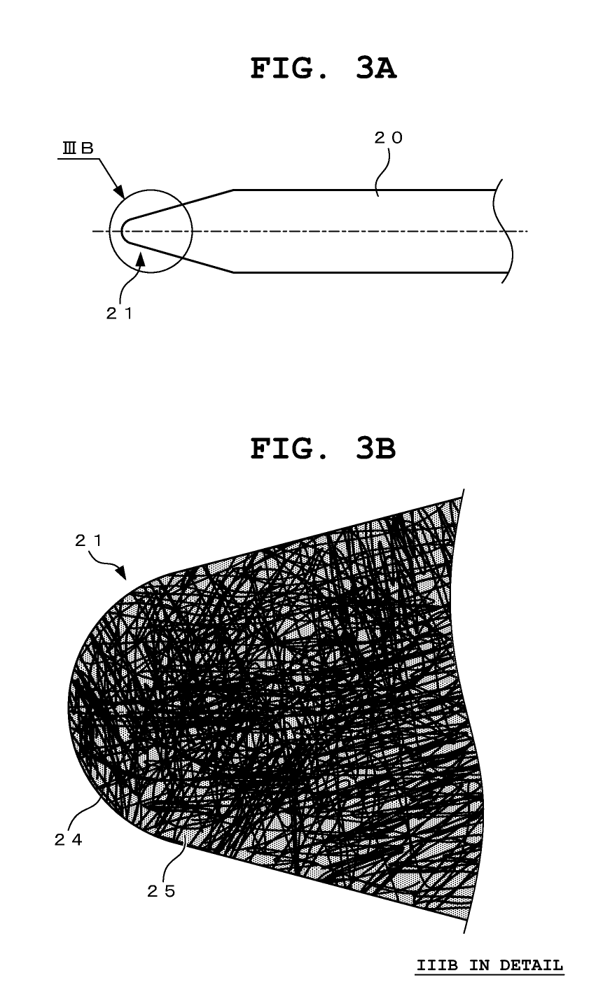

FIG. 3A and FIG. 3B are schematic diagrams showing the pen tip of the input pen according to the second embodiment, of which FIG. 3A is a diagram showing the pen tip of the input pen according to the second embodiment, and FIG. 3B is a cross-sectional view showing a detailed structure of section IIIB shown in FIG. 3A.

In the first embodiment described above, a structure in which the porous pen tip member 20 is impregnated with a resin material (rubber material) and the manufacturing method thereof has been described. In the second embodiment, a structure in which a fibrous material is mixed with a resin material and molded, and the manufacturing method thereof are described.

The input pen according to the second embodiment includes the pen body 10 and the pen tip member 20, as in the case of the above-described input pen 1 of the first embodiment. Specifically, at least the tip end portion 21 of the pen tip member 20 is mixed and fabricated using a fibrous material 24, such as glass fibers, carbon fibers, or metal fibers, and a material (mixing material) 25 having the properties of rubber, as shown in FIG. 3A and FIG. 3B. That is, a material having the properties of rubber and relatively low viscosity is mixed and fabricated with the fibrous material 24 constituting the tip end portion 21 of the pen tip member 20. As a result, the fibrous material 24 and the material having the properties of rubber become unified, and a structure is achieved in which a portion of the material having the properties of rubber is exposed on the surface of the tip end portion 21. In this process, the material (mixing material) 25 mixed with the fibrous material 24 is held in the spaces between the fibers of the fibrous material 24, and adhered to the fibrous material 24 surrounding the mixing material 25. As a result, the mixing material 25 and the fibrous material 24 are united with high bonding strength. This mixing material 25 is partially exposed on the surface of the tip end portion 21 of the pen tip member 20.

This structure also ensures the rigidity of the pen tip member 20 and the tip end portion 21 while ensuring the flexibility and the friction of rubber in only the interface where the input pen and a touch panel come in contact with each other, as in the case of the first embodiment. That is, in the second embodiment, a fibrous material, such as glass fibers, carbon fibers, or metal fibers, and a resin material having the properties of rubber are mixed and molded, and as a result strong fibers are present within the pen tip member 20, whereby the rigidity and the flex resistance are further improved. Accordingly, in the second embodiment as well, the buckling, deformation, breakage, cracks, and the like of the pen tip of an input pen is prevented and a favorable writing feeling (flexibility and sense of friction) is actualized even when touching and sliding back and forth the pen tip on a touch panel at a predetermined pressure (writing pressure) during an input operation.

(Example of Application)

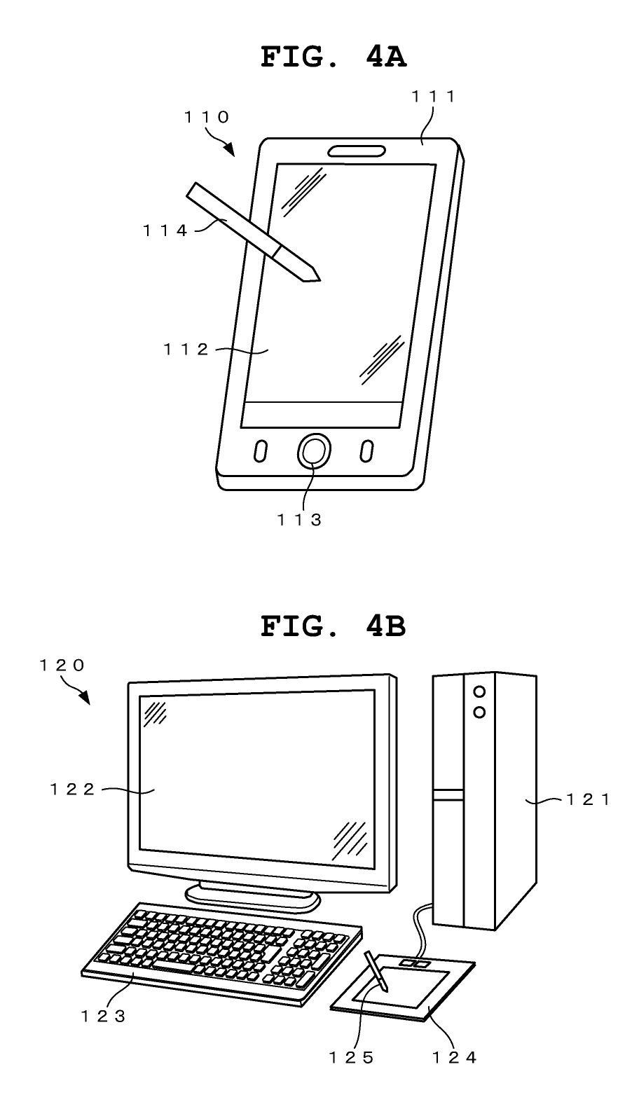

FIG. 4A and FIG. 4B are schematic diagrams showing structural examples of electronic devices to which the input pen of the present invention has been applied, of which FIG. 4A is a perspective view of a structural example of a highly functional mobile phone, and FIG. 4B is a perspective view of a structural example of a personal computer.

As shown in FIG. 4A and FIG. 4B, the input pen 1 according to the above-described embodiments can be favorably applied to various electronic devices.

In short, an electronic device 110 in FIG. 4A, such as a smartphone or a mobile information terminal, includes a main body section 111, a display section 112 including a resistive film type touch panel, an input operation section 113, and an input pen (stylus pen) 114 having a structure equivalent to that of the input pen according to the above-described embodiments. In this example, during an input operation on the display section 112 by the input pen 114, buckling, deformation, and the like of the pen tip is prevented and a favorable writing feeling is actualized.

Also, an electronic device 120 in FIG. 4B, such as a desktop personal computer, includes a computer main body section 121, a display section 122, a keyboard 123, an electromagnetic induction type pen tablet 124, and an input pen (electronic pen) 125 having a structure equivalent to that of the input pen according to the above-described embodiments. In this example as well, during an input operation on the pen tablet 124 by the input pen 125, any buckling, deformation, and the like of the pen tip is prevented and a favorable writing feeling is actualized.

In the above-described application examples, there are shown electronic devices using the resistive film type or electromagnetic induction type touch panel that are generally recognized as touch panels capable of pen input. However, the present invention is not limited thereto. That is, the present invention can also be applied to electronic devices using the capacitance type touch panel that is generally recognized as a touch panel incapable of touch input by using a conductive material for at least one of the base member 22 constituting the pen tip member 20 and the impregnation material in the above-described first embodiment, and setting the conductivity to be almost equivalent to that of the human body (finger). In this instance as well, the writing feeling of the input pen is soft and the pen tip slides so that the desired input operation can be favorably performed. Also, this desired input operation with a favorable writing feeling can be similarly performed in electric devices using a capacitance type touch panel, by using a conductive material for at least one of the fibrous material and the mixing material constituting the pen tip member 20 in the second embodiment, and setting the conductivity to be almost equivalent to that of the human body (finger).

While the present invention has been described with reference to the preferred embodiments, it is intended that the invention be not limited by any of the details of the description therein but includes all the embodiments which fall within the scope of the appended claims.

What is claimed is:

1. An input pen comprising:
a pen tip member which has a porous base member and a rubber material,
wherein the rubber material is united with the porous base member within the porous base member, and partially exposed at least on surface of the porous base member.

2. The input pen according to claim 1, wherein the porous base member is structured such that the pen tip member has a predetermined flexural strength when touching and sliding back and forth the input pen on a contact object.

3. The input pen according to claim 1, wherein the rubber material is structured such that the pen tip member has a predetermined flexibility and friction when touching and sliding back and forth the input pen on a contact object.

4. The input pen according to claim 1, wherein the rubber material is an impregnation material that is impregnated into interior of the porous base member by impregnation processing.

5. The input pen according to claim 4, wherein the impregnation material forms vesicles in a pore section of the porous base member, and the impregnation material and the porous base member are united with each other by the impregnation material being surrounded by the porous base member.

6. The input pen according to claim 5, wherein the vesicles of the impregnation material are partially exposed on surface of a tip end portion of the pen tip member.

7. The input pen according to claim 6, wherein the tip end portion of the pen tip member has a hemispherical shape or a convex shape with a predetermined roundness.

8. The input pen according to claim 1, wherein the porous base member includes wood or a foamed resin.

9. The input pen according to claim 1, wherein the porous base member contains a fibrous material and the pen tip member is integrally formed by mixing a mixing material composed of the rubber material and the fibrous material.

10. The input pen according to claim 9, wherein the mixing material mixed with the fibrous material is held in spaces between fibers of the fibrous material, and the mixing material and the fibrous material are united by adhering to the fibrous material surrounding the mixing material.

11. The input pen according to claim 10, wherein the mixing material is partially exposed on surface of a tip end portion of the pen tip member.

12. The input pen according to claim 11, wherein the tip end portion of the pen tip member has a hemispherical shape or a convex shape with a predetermined roundness.

13. The input pen according to claim 9, wherein the fibrous material includes glass fibers, carbon fibers, or metal fibers.

14. The input pen according to claim 1, wherein the rubber material includes natural rubber.

15. The input pen according to claim 1, wherein the rubber material is composed of an organic synthetic rubber including nitrile rubber or butadiene rubber.

16. The input pen according to claim 1, wherein the rubber material is composed of a non-organic synthetic rubber including silicone rubber or fluoro-rubber.

17. The input pen according to claim 1, wherein the pen tip member is attached and fixed to an end portion of a pen body.
